(19) United States
(12) Patent Application Publication
(10) Pub. No.: US 2004/0180619 A1
(43) Pub. Date: Sep. 16, 2004

(54) Coin selecting machine with improved dragging system

(76) Inventor: Fabiano Picollo, Capriata d'Orba (IT)

Correspondence Address: JACOBSON HOLMAN PLLC, 400 SEVENTH STREET N.W., SUITE 600, WASHINGTON, DC, 20004, US

(21) Appl. No.: 10/790,754

(22) Filed: Mar. 3, 2004

(30) Foreign Application Priority Data
Mar. 11, 2003 (IT) MI2003A 000453

(51) Int. Cl. G07D 3/00; G07D 7/00

(52) U.S. Cl. 453/7; 194/302

(57) ABSTRACT

A coin selecting machine comprises a coin feeder (11) which feeds sequentially coins resting with one of their sides on a flow plane (16). A selection device (13) comprises sequential apertures (31) for passage of the coins according to their diameter and the coins are dragged over said apertures by means of a powered conveyor belt (33) facing on the flow plane (16). The selection device (13) comprises a sequence of pulleys (37) arranged over the apertures (31) and resting on the belt (33). Each pulley of the plurality is supported in a rotating manner by its own pin (38) which allows elastic movement of the pulley such that when no coin passes between the belt (37) and the plane (16) opposite the pulley, the pulley has its rotation axis at a first distance from the plane and when a coin passes between the belt and the plane opposite the pulley the axis is pushed against an elastic force to a second and greater distance from the plane and when a coin falls into the underlying aperture for passage the axis returns elastically to said first distance and goes beyond it in the direction of the plane in such a manner as to push the coin into the aperture.

### BACKGROUND OF THE INVENTION

1. Field of the Invention

The present invention relates to a coin-selecting machine with an innovative dragging system allowing improved performance.

2. State of the Prior Art

In the prior art coin selecting machines which perform selection of coins while conveying them sequentially on an appropriately pierced plane so that each coin falls into a respective duct on the basis of the coin diameter are known. Usually the coins slide guided and aligned on a plane to encounter holes progressively larger so as to select the coins from the smaller diameter to the larger. To convey the coins along the plane a powered toothed belt arranged parallel to and above the coin flow plate is used to press with force on the coins and drag them by friction lodged between the plate and the belt.

In such known systems the tension needed by the toothed belt to function adequately makes the belt relatively rigid and this requires high pressure of the belt on the coins. But said pressure is detrimental for conveyance of the coins, which scrape with one of their sides on the pierced plate with the resulting friction and wear of the contact surfaces.

The situation has even worsened due to the fact that coins of different diameters also usually have different thickness. The belt must be sufficiently close to the coin flow plate to ensure dragging contact between the belt and the coins with smaller thickness. The thicker coins are therefore compressed by the belt with greater force than would be necessary for dragging.

Despite the considerable pressure applied by the belt on the coins it might happen that at relatively high dragging speeds the inertia of movement of the coins would take a coin to bypass the aperture of the diameter associated with it and fall into the next aperture, which is of larger size, with resulting selection error.

The general purpose of the present invention is to remedy the above-mentioned shortcomings by making available a selecting machine with an innovative low-pressure dragging system for contact with the coins and with surer selection operation.

### SUMMARY OF THE INVENTION

In view of said purpose it was sought to provide in accordance with the present invention a coin selecting machine comprising a coin feeder sequentially feeding coins resting with one of their sides on a flow plane with along the path of the coins there being a selection device comprising in said flow plane sequential apertures for passage of the coins according to their diameter with the coins being dragged over the apertures by means of a powered conveyor belt facing on the flow plane and characterized in that the selection device comprises along a selection path a sequence of pulleys arranged over the apertures in the plane to rest on said belt with one of its sides which is opposite the one facing the flow plane with the pulleys being spaced from each other in such a manner that each passage for a coin diameter comprises at least one pulley of the plurality and each pulley of the plurality is supported in a rotating manner by its own pin which is in turn supported at a distance from the pulley and allows elastic movement of the pulley such that when no coin passes between the belt and the plane opposite the pulley the pulley has a rotation axis at a first distance from the plane and when a coin passes between the belt and the plane opposite the pulley the axis is pushed against an elastic force to a second and greater distance from the plane and when a coin falls into the underlying aperture for passage the axis returns elastically to said first distance and goes beyond it in the direction of the plane in such a manner as to push the coin into the aperture.

### BRIEF DESCRIPTION OF THE DRAWINGS

To clarify the explanation of the innovative principles of the present invention and its advantages compared with the prior art there is described below with the aid of the annexed drawings a possible embodiment thereof by way of non-limiting example applying said principles. In the drawings:

FIG. 1 shows a diagrammatic front view of the machine in accordance with the present invention, and

FIG. 2 shows a partially cross-sectioned view along plane of cut II-II of FIG. 1 of a detail of the machine.

### DETAILED DESCRIPTION OF THE INVENTION

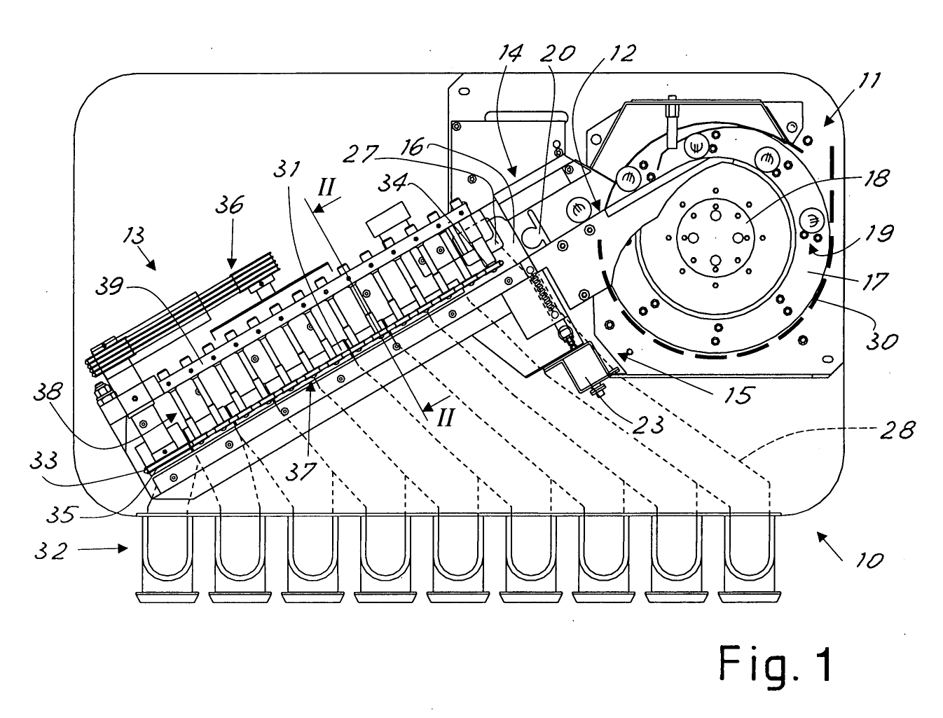

With reference to the figures, FIG. 1 shows diagrammatically a machine, indicated as a whole by reference number 10, for selection and counting of coins. The machine comprises a known coin feeder 11 which feeds the coins sequentially to channel them in a flow of coins which roll along a narrow guide with inclined plane or knife 12 to a handling device 13 which sorts the coins by diameter.

Before the handling device 13 there can be provided a known electronic verification device 14 and an electromechanical rejection device 15. In accordance with the prior art the verification device with its own sensors 20 (for example optical and/or inductive) checks the coins transiting for agreement with predetermined parameters and commands the rejection device to reject the coins that are not considered acceptable. The parameters checked could be chosen for example from among diameter, magnetic permeability at various points, thickness, degree of light reflection, profile et cetera.

The electromechanical rejection device 15 can be of any known type and is not described in detail here. Advantageously it can comprise an actuator 23 (for example a solenoid) which on command diverts the coin to be rejected to direct it to a passage 27 leading to a rejection path 28.

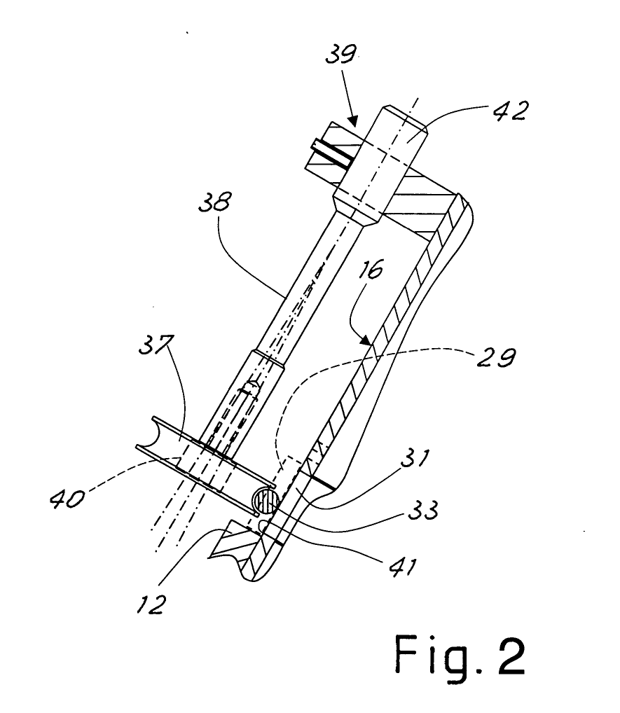

The support plane 16 for the side of the coins that roll on the inclined plane 12 is in turn inclined backward as may be seen in FIG. 2. Said support plane is of wearproof steel and can be made from a plane bearing the narrow knife guide 12 fastened laterally that realizes the inclined plane.

It was found preferable that the inclinations of the inclined plane 12 and of the support face 16 be held around 30° and 60° respectively.

The feeder 11 is advantageously realized with a container 30 (for example with a capacity of 2000 to 4000 coins) inclined so as to convey the coins placed in it to the lower part of a feed disk 17 which is also inclined like the flow plane 16. The disk rotates counterclockwise by means of a gear motor 18 at a speed included for example between 50 and 90 rpm. On the side of the disk near its periphery are arranged pairs of rungs 19 spaced circumferentially and uniformly. With a known cam mechanism (readily imaginable to those skilled in the art and therefore not shown in detail) the rungs emerge from the disk when they are in the lower part of the disk and reenter when they are high. In this manner the disk, which forms an inclined wall, picks up the coins on the bottom of the container and drags them upward to abandon them sequentially on the higher part of the inclined knife 12. Once the knife is reached the coins are channeled in aligned and orderly manner and roll resting with their circumferential edge on the knife. Only their rolling and sliding friction limit the speed of descent of the coins along the knife.

After passage through the verification device 14 and rejection of any unacceptable coins the coins reach the device 13 sequentially while rolling again on the knife 12 and dragging on the plane 16. The selecting device 13 comprises a sequence of apertures or passages 31 made in the plate 16 and having progressively increasing breadth depending on the various diameters of the coins it is wished to select. The sequence of apertures is advantageously realized with a single stepped slot.

In this manner the various coins 29 fall through the first passage 31 which they encounter with size greater than their own diameter. With the passages 31 are associated separate channels 32 which convey the selected coins towards their final destination, for example collection boxes or bags (not shown).

The selecting device 13 comprises coin dragging means that stabilize the speed of the coins flowing on the plane so as to avoid selection defects and keep the coins supported on the knife guide 12.

As may be seen in FIG. 1 and in particular in FIG. 2 the dragging means comprise an elastic belt, for example of polymers, with round cross section 33 which rotates supported by two snub pulleys 34, 35 placed at the two ends of the selection section of the device 13. The belt is virtually parallel to the inclined plane 12 with advantageously only a slight approach to the knife in the direction of movement of the coins so as to give the coins also a component of thrust towards the knife and ensure that they remain adhering thereto.

The downstream pulley 35 is the powered dragging pulley and is connected to a motor 36. In this manner the coins are drawn and not pushed by the belt.

Both the pulleys can have known adjustment means (not shown in detail) to allow their appropriate positioning.

Advantageously, the idle pulley 34 is positioned raised by the plane 16 so that even the thicker coins do not exert pressure thereon when entering the selection path of the device 13.

Between the front-end idle pulley and the driving pulley are positioned in closely aligned sequence idle pulleys 37 that at the bottom are near the outward branch of the belt. As may be seen in FIG. 2, each pulley is supported by an elastically yielding pin or flexor 38 in turn supported at a point 39 relatively distant from the pulley. The pulley can be advantageously supported on its own pin by means of a self-aligning bearing 40, i.e. of the known type allowing inclination of the pulley rotation axis with respect to the pin axis. In this manner the pulley keeps its plane of rotation aligned with the belt. The space between the belt and the underlying plane can be reduced to a minimum and kept right to avoid dragging of the belt on the plane. The distance between each pulley 37 and the support point 39 of the pin and the pliability of the pin are such as to have a support of the pulley 37 which is elastically yielding at least in the direction normal to the coin flow plane 16 by an amount such as to allow rising of the pulley from the plane sufficient to allow passage of the thickest coin.

Advantageously the entire pin 38 is realized elastically flexible with a central zone thin enough to have the desired pliability.

The end 42 of the pin opposite the pulley is inserted in a sliding manner in a complementary hole in the support 39 and is locked by means of a dowel 43. In this manner the axial position of each pulley is adjustable with precision. When a conveyed coin reaches the zone of the apertures 31 corresponding to its own diameter, support for the coin is lacking. Advantageously on the side of the guide 12 there remains a small step 41 for support of the coins (FIG. 2) so that the support is lacking mainly in the upper part of the coin.

The belt, which presses on the coin due to the flexors, exerts on the coin a thrust force towards the plane 16. In addition, as the flexors do not have a stop towards the plane, in addition to exerting thrust on the natural plane of the belt, when the coin is thrust through the appropriate aperture 31, they start a pendulum effect that takes the rotation axis of the pulley to go beyond the intermediate neutral point. This is shown diagrammatically in FIG. 2 where the first intermediate distance of the axis from the plane is seen in dot and dash lines for the pin axis, the greater distance of the axis from the plane because of the passage of a coin and the lesser distance of the axis from the plane because of the thrust effect of a coin in the underlying passage.

The belt, being the elastic type with small cross-section, opposes a negligible resistance to the pendulum effect triggered by the flexors. This effect ensures that the coin is thrust beyond the natural plane of the belt and hence with safety in the channel beneath the aperture. All this allows keeping high feed speed without the risk of the coins “jumping over” the associated aperture and falling into the next aperture that is broader.

The “pendulum-thrust” pulleys are sufficiently close together so that at least one pulley pushes on a coin for each fall aperture. For the larger coins, two thrust pulleys are in action simultaneously. The pulleys can be advantageously separated by a space smaller than their diameter.

It is now clear that the predetermined purposes have been achieved by supplying a machine that allows in a simple manner low wear and high reliability in coin selection. Naturally the above description of an embodiment applying the innovative principles of the present invention is given by way of non-limiting example of said principles within the scope of the exclusive right claimed here. For example, various known rejection and verification devices can be used just as various known sequential coin feeders. The machine can also have more or less fall paths for selecting a different number of coins depending on the preferences and practical necessities of use. Although the solution with pulley pin in a single piece of flexible material was found preferable due to its simplicity, variants can be used. For example, a three-part pin can be imagined, i.e. two rigid end parts for fastening the pulley to the support 39 and the central one elastically yielding. Said central part can be realized for example with an appropriate helical spring. As an alternative, the pin can be virtually yielding and fastened to the support 39 to have pendulum movement opposed by added elastic members, for example a pair of leaf springs over and under the pin.

What is claimed is:

1. Coin selecting machine comprising a coin feeder which feeds sequentially coins resting with one of their sides on a flow plane with along the path of the coins there being a selection device comprising in said flow plane sequential apertures for passage of the coins according to their diameter with the coins being dragged over the apertures by means of a powered conveyor belt facing on the flow plane and characterized in that the selection device comprises along a selection path a sequence of pulleys arranged over the apertures in the plane to rest on said belt on its side opposite the one facing the flow plane with the pulleys being spaced from each other in such a manner that each passage for a coin diameter comprises at least one pulley of the plurality and each pulley of the plurality is supported in a rotating manner by its own pin which is in turn supported at a distance from the pulley and allows elastic movement of the pulley such that when no coin passes between the belt and the plane opposite the pulley the pulley has its rotation axis at a first distance from the plane, and when a coin passes between the belt and the plane opposite the pulley the axis is pushed against an elastic force to a second and greater distance from the plane and when a coin falls into the underlying aperture for passage the axis returns elastically to said first distance and goes beyond it in the direction of the plane in such a manner as to push the coin into the aperture.

2. Machine in accordance with claim 1 characterized in that with the axis in said first distance from the plane the pulley impresses a minimal thrust on the belt so that opposite the pulley the belt is virtually in its natural plane.

3. Machine in accordance with claim 1 characterized in that the pin is supported rigidly near one of its ends opposite the pulley and is realized at least partially of elastically flexible material to allow said elastic movement of the pulley.

4. Machine in accordance with claim 1 characterized in that from the flow plane projects beside the apertures a guide along which the coins flow supported on their own peripheral edge.

5. Machine in accordance with claim 4 characterized in that between the guide and the passage apertures the flow plane identifies a peripheral support step for the coins.

6. Machine in accordance with claim 4 characterized in that said guide is inclined downward with respect to the horizontal along the direction of movement of the coins.

7. Machine in accordance with claim 6 characterized in that the inclination of the guide is around 30°.

8. Machine in accordance with claim 1 characterized in that the flow plane is inclined with respect to the horizontal transversely to the coin movement direction.

9. Machine in accordance with claim 8 characterized in that the inclination of the flow plane is around 60°.

10. Machine in accordance with claim 4 characterized in that the belt is inclined with respect to said guide to draw near the guide in the coin dragging direction in such a manner as to supply a thrust component for the coins against the guide.

11. Machine in accordance with claim 1 characterized in that the belt is a belt with round cross section.

12. Machine in accordance with claim 1 characterized in that the belt is an elastic belt of polymers.

13. Machine in accordance with claim 1 characterized in that the pulleys of the plurality are spaced from each other by a distance smaller than their diameter.

14. Machine in accordance with claim 1 characterized in that the belt winds on two snub pulleys at the ends of the selection path with the pulley at the end of the path being the one powered for running of the belt.

15. Machine in accordance with claim 1 characterized in that along the path of the coins between the coin feeder and the selection device there are devices for verification of the characteristics of the coins and rejection of coins not meeting predetermined parameters of acceptability of the coins.

16. Machine in accordance with claim 15 characterized in that the verification device detects the characteristics of the selected coins from among diameter, magnetic permeability at several points, thickness, light reflection, profile and position.

17. Machine in accordance with claim 1 characterized in that the coin feeder comprises a powered disk rotating with inclined axis to pick up coins from a container by means of its side projections and release them onto said inclined plane.

18. Machine in accordance with claim 17 characterized in that the projections are in the form of pairs of pins movable axially and synchronously with the rotation of the disk between a position of conveyance projecting from the side wall of the disk and a position of release retracted into said wall.
